(19) United States
(12) Patent Application Publication
(10) Pub. No.: US 2014/0367497 A1
(43) Pub. Date: Dec. 18, 2014

(54) Sprinkler

(71) Applicant: Pai-Chou Hsieh, Chang-Hua County (TW)

(72) Inventor: Pai-Chou Hsieh, Chang-Hua County (TW)

(21) Appl. No.: 13/920,132

(22) Filed: Jun. 18, 2013

(51) Int. Cl. B05B 9/01; B05B 12/00

(52) U.S. Cl. CPC B05B 9/01; B05B 12/002
USPC 239/526

(57) ABSTRACT

A sprinkler includes a body, a nozzle, a grip, a decorative element and a handle. The body includes a tube in communication with a cylinder. The nozzle is connected to the cylinder. The grip includes a space for receiving the tube and the cylinder and two openings in communication with the cylinder. The decorative element includes two lateral portions each including a ring placed around a corresponding one of the openings. The handle includes two semi-handles for pressing the rings on the grip.

### BACKGROUND OF INVENTION

1. Field of Invention

The present invention relates to a sprinkler and, more particularly, to an aesthetically pleasant, light and inexpensive sprinkler.

2. Related Prior Art

A conventional sprinkler includes a body and a decorative element. The body is made of plastics by injection molding. The decorative element is made of metal by casting. The decorative element provides a metallic look. The body is formed with a lug. The decorative element is formed with a cap. The lug is placed in the cap. The decorative element is attached to the body by inserting a screw in the cap and the lug. The decorative element is however bulky, heavy and expensive because it is made of metal by casting.

The present invention is therefore intended to obviate or at least alleviate the problems encountered in prior art.

### SUMMARY OF INVENTION

It is the primary objective of the present invention to provide an aesthetically pleasant, light and inexpensive sprinkler.

To achieve the foregoing objective, the sprinkler includes a body, a nozzle, a grip, a decorative element and a handle. The body includes a tube in communication with a cylinder. The nozzle is connected to the cylinder. The grip includes a space for receiving the tube and the cylinder and two openings in communication with the cylinder. The decorative element includes two lateral portions each including a ring placed around a corresponding one of the openings. The handle includes two semi-handles for pressing the rings on the grip.

Other objectives, advantages and features of the present invention will become apparent from the following description with reference to the attached drawings.

### BRIEF DESCRIPTION OF DRAWINGS

The present invention will be described via detailed illustration of the preferred embodiment versus the prior art referring to the drawings wherein:

FIG. 1 is a perspective view of a sprinkler according to the preferred embodiment of the present invention;

FIG. 2 is an exploded view of the sprinkler shown in FIG. 1;

FIG. 3 is a front view of a decorative element of the sprinkler of FIG. 1;

FIG. 4 is an enlarged, partial, perspective view of the decorative element shown in FIG. 3;

FIG. 5 is a cross-sectional view of the sprinkler shown in FIG. 1; and

FIG. 6 is another cross-sectional view of the sprinkler shown in FIG. 1.

### DETAILED DESCRIPTION OF PREFERRED EMBODIMENT

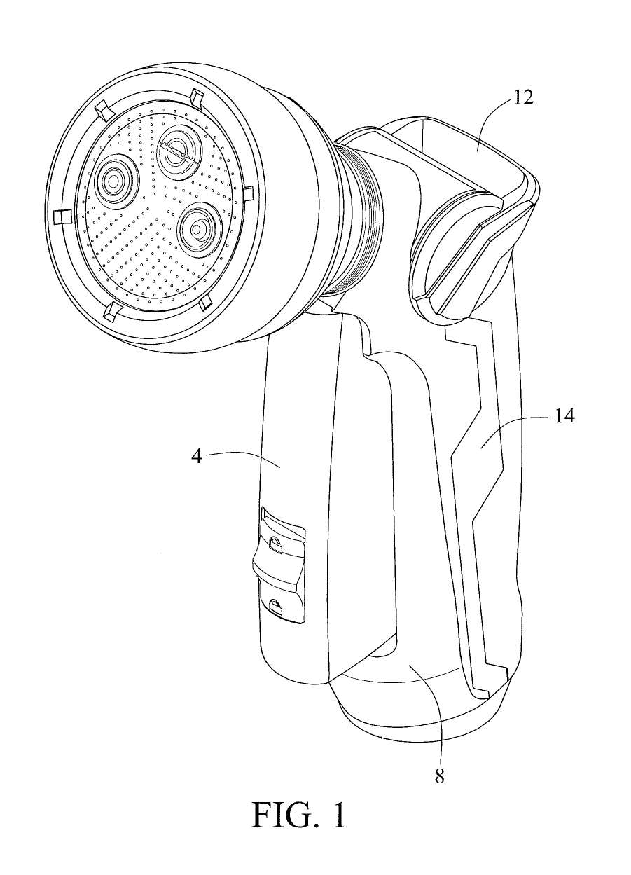

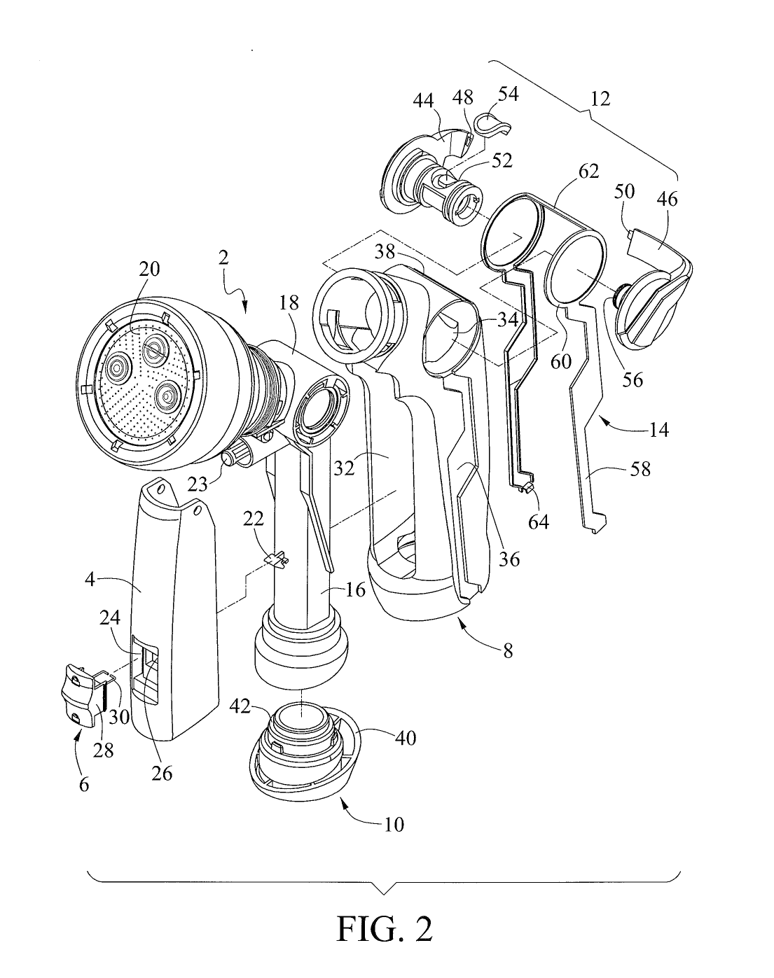

Referring to FIGS. 1 and 2, shown is an aesthetically pleasant, light and inexpensive sprinkler according to the preferred embodiment of the present invention. The sprinkler includes a body 2, a lever 4, a lock 6, a grip 8, an end element 10, a handle 12 and a decorative element 14.

The body 2 is made of plastics. The body 2 includes a tube 16 and a cylinder 18. The tube 16 is in communication with the cylinder 18. The nozzle 20 is connected to the cylinder 18 so that they nozzle 20 is in communication with the cylinder. A hook 22 is formed on a front face of the tube 16.

A plunger 23 is used to control the communication of the nozzle 20 with the cylinder 18. The plunger 23 includes an end placed out of the cylinder 18 and another end placed in the cylinder 18. The plunger 23 can be pushed to communicate the nozzle 20 with the cylinder 18. The plunger 23 can be released to block the nozzle 20 from the cylinder 18.

The lever 4 is made of plastics. The lever 4 includes a groove 24 and an aperture 26. The groove 24 is in communication with the aperture 26.

The lock 6 is made of plastics. Skid-proof ribs 28 are formed on a front face of the lock 6. A loop 30 is attached to a rear face of the lock 6.

The grip 8 is made of plastics. Preferably, the grip 8 is made of a soft plastic material to provide a user with comfortable feel. The grip 8 includes a space 32, two openings 34, two lateral cavities 36 and a transverse cavity 38. The space 32 is in communication with the openings 34. Each of the openings 34 is in communication with a corresponding one of the lateral cavities 36. The transverse cavity 38 is in communication with both of the lateral cavities 36.

The end element 10 is made of plastics. The end element 10 includes a cup 40 and a hollow insert 42. The cup 40 and the hollow insert 42 are coaxial, with the cup 40 extending around the hollow insert 42.

The handle 12 is made of plastics. The handle 12 includes two semi-handles 44 and 46. The semi-handle 44 includes a recess 48 in an end. The semi-handle 46 includes an insert 50 at an end.

A valve 52 is formed on the semi-handle 44. A packing 54 is attached to the valve 52. A shaft 56 is formed on the semi-handle 46.

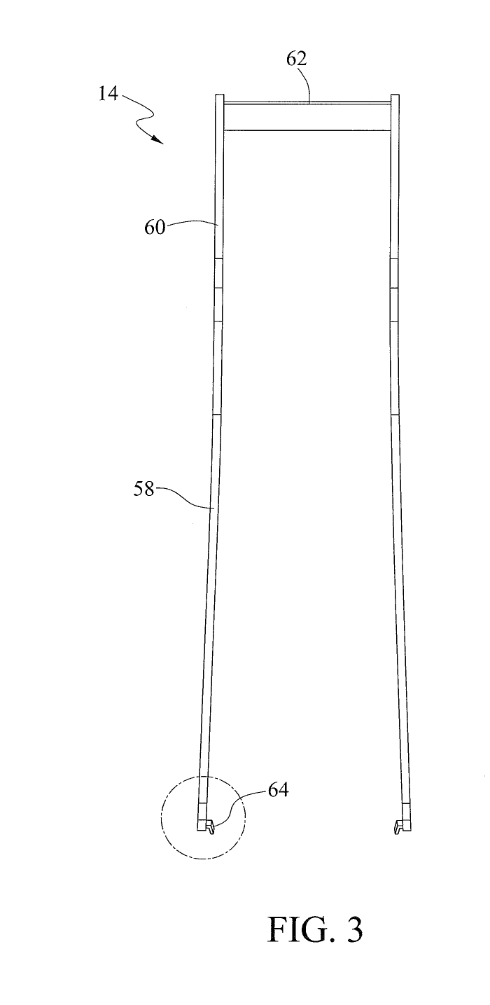

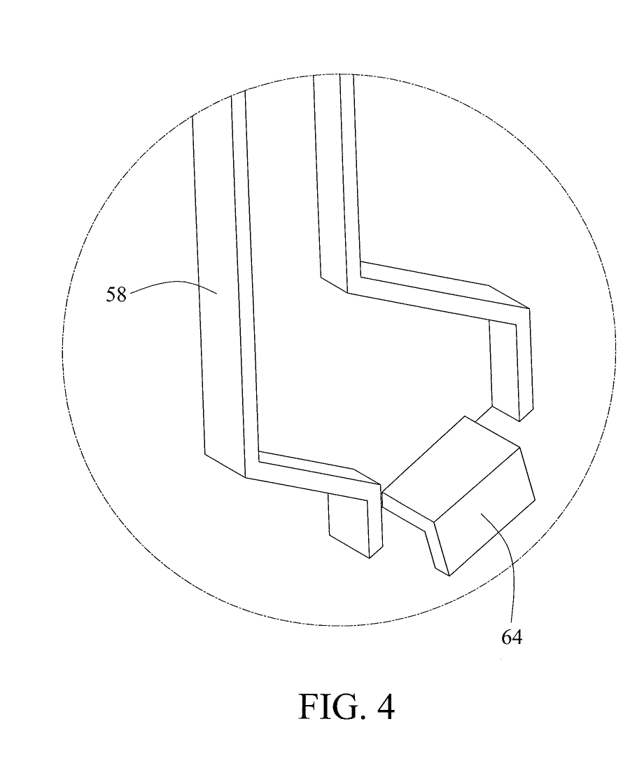

Referring to FIGS. 2 to 4, the decorative element 14 is a thin, light and inexpensive element that is made by punching a metal sheet. The decorative element 14 includes two strips 58, two rings 60 and a crossbar 62. Each of the rings 60 is formed at an end of a corresponding one of the strips 58. The cross bar 62 is formed between the rings 60. A tab 64 is formed at a lower end of each of the strips 58. The tab 64 includes a first portion extending perpendicular to the corresponding strip 58 and a second portion extending parallel to the corresponding strip 58. Each strip 58, the corresponding ring 60 and the corresponding tab 64 together form a lateral portion of the decorative element 14.

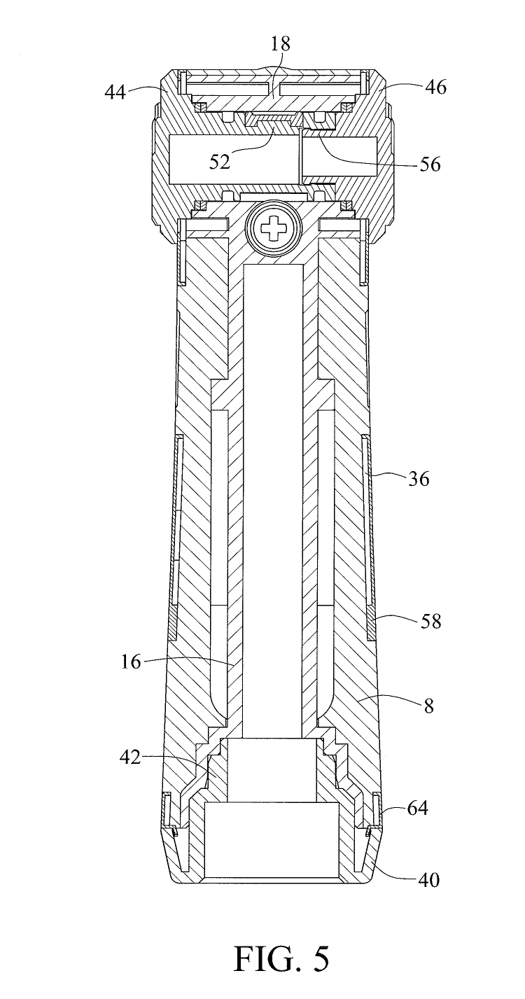

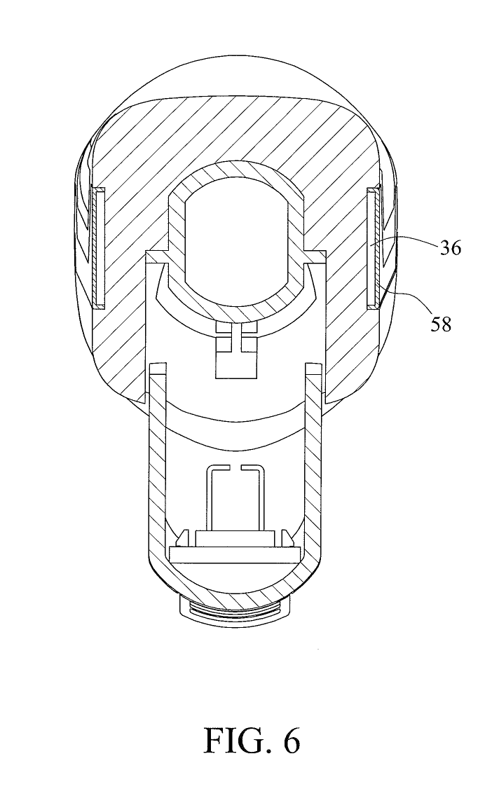

Referring to FIGS. 5 and 6, the lever 4 is pivotally connected to the body 2 by a pin (not shown) inserted through the body 2 or two bosses (not shown) formed on the body 2. The lock 6 is movably placed in the groove 24, with the loop 30 inserted through the aperture 26. The loop 30 can be engaged with the hook 22 for locking the lever 4 to the body 2.

The tube 16 and the cylinder 18 of the body 2 are placed in the space 32 of the grip 8. Two open ends of the cylinder 18 are in communication with the openings 34. The hollow insert 42 of the end element 10 is inserted in a lower end of the tube 16. The cup 40 is placed beneath a lower end of the grip 8. The interior of the cup 40 is in communication with the lateral cavities 36.

The decorative element 14 is attached to the grip 8. Each of the strips 58 of the decorative element 14 is placed in a corresponding one of the lateral cavities 36 of the grip 8. Each of the rings 60 is placed around a corresponding one of the openings 34. The cross bar 62 is placed in the transverse cavity 38. The second portion of each of the tabs 64 is placed against an internal side of the cup 40 to avoid pivoting of the strips 58 from the grip 8.

The valve 52 is inserted in the cylinder 18 through one of the openings 34 and one of the rings 60. The shaft 56 is inserted in the cylinder 18 through the other opening 34 and the other ring 60. In the cylinder 18, the shaft 56 is fit in the free end of the valve 52 so that the valve 52 can smoothly rotate in the cylinder 18. The insert 50 is inserted in the recess 48. The semi-handle 46 is secured to the semi-handle 44 by adhesive for example. Each of the rings 60 is sandwiched between a corresponding flank of the grip 8 and a corresponding one of the semi-handles 44 and 46.

The decorative element 14 is kept on the grip 8 since each ring 60 is sandwiched between the corresponding flank of the grip 8 and the corresponding semi-handle 44 or 46 while the second portion of each tab 64 is placed against the internal side of the cup 40.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A sprinkler including:
a body including a tube and a cylinder in communication with the tube;
a decorative element including two lateral portions each including a ring placed around an open end of the cylinder; and
a handle including two semi-handles for pressing the rings on the grip.

2. The sprinkler according to claim 1, including a grip placed on the body and made with two openings in communication with the cylinder, wherein the ring of each of the lateral portions of the decorative element is placed around a corresponding one of the openings.

3. The sprinkler according to claim 1, including an end element including an insert inserted in the tube and a cup placed against the grip, wherein each of the lateral portions of the decorative element includes a tab placed between the grip and the cup.

4. The sprinkler according to claim 3, wherein the grip includes two lateral cavities for receiving the lateral portions of the decorative element, wherein the lateral cavities are in communication with the interior of the cup to allow the insertion of the tabs into the interior of the cup from the lateral cavities.

5. The sprinkler according to claim 4, wherein the decorative element includes a crossbar formed between the lateral portions thereof, wherein the grip includes a transverse cavity for receiving the crossbar.

6. The sprinkler according to claim 1, wherein one of the semi-handles includes a recess while the other semi-handle includes an insert inserted in the recess.

7. The sprinkler according to claim 1, including a valve formed on one of the semi-handles and a shaft formed on the other semi-handle, wherein the shaft is connected to the valve in the cylinder.

8. The sprinkler according to claim 7, wherein the shaft is inserted in the valve.

9. The sprinkler according to claim 1, wherein the decorative element is a thin element made of a metal sheet by punching.

10. The sprinkler according to claim 1, including a lever pivotally connected to the body and a plunger including an end in contact with the lever and another end inserted in the cylinder.
